(19) United States
(12) Patent Application Publication
(10) Pub. No.: US 2017/0034338 A1
(43) Pub. Date: Feb. 2, 2017

(54) CELL PHONE DISABLING CONTAINER

(71) Applicant: Ronda Hunsaker, Emmett, ID (US)

(72) Inventor: Ronda Hunsaker, Emmett, ID (US)

(21) Appl. No.: 14/814,700

(22) Filed: Jul. 31, 2015

(51) Int. Cl. H04M 1/725

(52) U.S. Cl. CPC H04M 1/72577

(57) ABSTRACT

A method of controlling cellular phone usage includes the steps of: supplying a cellphone container for an interior of a motor vehicle; integrating the cellphone container with circuitry related to the operation of the motor vehicle; disabling the operation of the motor vehicle through the cellphone container; enabling the operation of the motor vehicle after insertion of a cellular phone into a cavity of the cellphone container; and disabling the motor vehicle after removal of the cellular phone from the cavity. The step of integrating the cell phone container controls the motor vehicle's ignition and motor operation. The method of controlling cellular phone further includes integrating a latch within the cellphone container, where the latch secures the cellphone into the cavity.

### BACKGROUND OF THE INVENTION

Field of Invention

The present invention relates to a cell phone disabling container that is used and integrated with a motor vehicle.

Description of Related Art

As is well known many drivers use cell phones while driving and therefore increase the risk of accidents. Cell phones are quite popular in use and many individuals not only talk on the phone but engage or enact with the smartphone in other ways such as texting, searching the intern& or looking for directions. This type of distracted driving can cause various types of accidents unnecessarily. Although certain mobile applications have been developed that restrict cell phone usage within a motor vehicle, a more effective and reliable system is necessary to ensure that drivers are not engaging or using smartphones while operating a motor vehicle.

### SUMMARY OF THE INVENTION

The present invention relates to a method of controlling cellular phone usage includes the steps of: supplying a cellphone container for an interior of a motor vehicle; integrating the cellphone container with circuitry related to the operation of the motor vehicle; disabling the operation of the motor vehicle through the cellphone container; enabling the operation of the motor vehicle after insertion of a cellular phone into a cavity of the cellphone container; and disabling the motor vehicle after removal of the cellular phone from the cavity. The step of integrating the cell phone container controls the motor vehicle's ignition and motor operation. The method of controlling cellular phone further includes integrating a latch within the cellphone container, where the latch secures the cellphone into the cavity.

### BRIEF DESCRIPTION OF DRAWINGS

FIG. 1 depicts a bottom view of a cell phone container in accordance with the present invention.

FIG. 2 depicts a top view of a cell phone container in accordance with the present invention.

FIG. 3 depicts a side view of the cell phone container in accordance with the present invention.

### DETAILED DESCRIPTION

The present invention related to a cellular phone container that is integrated with the ignition and circuitry of a motor vehicle. The cell phone container disables a motor vehicle until a cellular phone is placed within the cell phone container therefore enabling the ignition of the vehicle. While in this cell phone container the driver will not be able to access and/or function the cellular phone. The cell phone container as a result disables the engine of the vehicle until the cell phone is placed within the container and must remain within the container for vehicle operation.

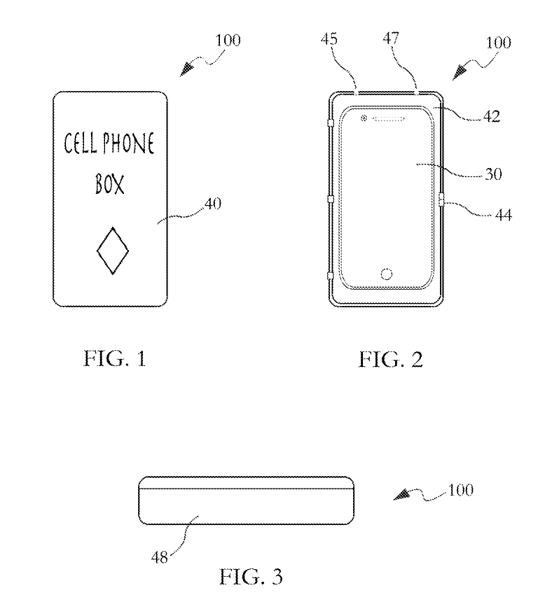

In reference to FIG. 1, a cell phone container 100 in accordance with the present invention is depicted. The Cell Phone Container 100 as shown in FIG. 1 is provided in a bottom view of the Container 100. This Bottom Side 40 is connected and integrated to the engine's circuitry and ignition to disable the engine prior to driving. FIG. 2 depicts a top view of the cellular phone container in accordance with the present invention. FIG. 2 depicts a Cell Phone 30 within the Container 40. A Cavity 42 is provided within the Container 100 that receives the Cell Phone 30. Once secured within the Container 100 the circuitry within the Container 40 engages and enables the ignition and operation of the motor vehicle's engine. Other features of the Container 40 include a Charging Mechanism 47 and a Latch 42, which secures the Cellular Phone 30 into the Cavity 42. A Power Connector 45 is also provided on the Container 40 to enable a supply of power to the Container 40 and Cellular Phone 30. The Cellular Container 100 is also shown in FIG. 3 depicting a side view with Side Wall 48 of the container. The Container 100 is preferably manufactured in various sizes and can accommodate various cellular phones within the Cavity 42. Once sealed within the Cavity 42 the circuitry of the phone engages the ignition and engine of the motor vehicle to allow operation of the vehicle only while the cellular phone remains within the Container 42. The instant invention has been shown and described in what it considers to be the most practical and preferred embodiments. It is recognized, however, that departures may be made there from within the scope of the invention and that obvious modifications will occur to a person skilled in the art.

What is claimed is:

1. A method of controlling cellular phone usage comprising the steps of:
a. supplying a cellphone container for an interior of a motor vehicle;
b. integrating the cellphone container with circuitry related to the operation of the motor vehicle;
c. disabling the operation of the motor vehicle through the cellphone container;
d. enabling the operation of the motor vehicle after insertion of a cellular phone into a cavity of the cellphone container; and
e. disabling the motor vehicle after removal of the cellular phone from the cavity.

2. The method of controlling cellular phone according to claim 1, where step of integrating the cell phone container controls the motor vehicle's ignition and motor operation.

3. The method of controlling cellular phone according to claim 1, further integrating a latch within the cellphone container, where the latch secures the cellphone into the cavity.

4. A system for controlling cellular phone usage comprising:
a. a cellphone container, where the cellphone container is positioned in an interior of a motor vehicle;
b. a means to integrate the cellphone container with circuitry related to the operation of the motor vehicle;
c. a means to disable the operation of the motor vehicle through the cellphone container;
d. a means to enable the operation of the motor vehicle after insertion of a cellular phone into a cavity of the cellphone container; and
e. a means to disable the motor vehicle after removal of the cellular phone from the cavity.
